(19) United States
(12) Patent Application Publication
(10) Pub. No.: US 2024/0343625 A1
(43) Pub. Date: Oct. 17, 2024

(54) Process for Removing Selenium from Wastewater Using Biological Reduction and Surface Complexation

(71) Applicant: Veolia Water Solutions & Technologies Support, Saint-Maurice (FR)

(72) Inventors: Marc Laliberté, LaSalle (CA); Myriam De Ladurantaye-Noël, L'Île-Bizard (CA)

(21) Appl. No.: 18/292,987

(22) PCT Filed: Jul. 5, 2022
(86) PCT No.: PCT/EP2022/068650

§ 371 Date: Jan. 29, 2024

Related U.S. Application Data
(60) Provisional application No. 63/227,366, filed on Jul. 30, 2021.

(51) Int. Cl. C02F 9/00; C02F 1/52; C02F 3/30; C02F 101/10; C02F 101/30

(52) U.S. Cl. CPC C02F 9/00; C02F 1/5245; C02F 3/30; C02F 2101/106; C02F 2101/30; C02F 2209/08; C02F 2209/15; C02F 2301/046; C02F 2305/06

(57) ABSTRACT

A process for removing selenium from water is described. Through a biological reduction process, selenium +6 species are reduced to selenium +4 species. A coagulant is mixed with the water and as a result, solids having complexation binding sites are formed. The reduced selenium +4 species is adsorbed onto the complexation binding sites of the solids. Thereafter, the solids having adsorbed selenium +4 species is separated from the water and ultimately separate from the process. The resulting effluent is subjected to a second biological treatment under aerobic conditions which converts residual selenium and organo-selenium to selenate.

### FIELD OF THE INVENTION

The present invention relates to systems and processes for removing selenium, and more particularly to biological and physio-chemical processes for removing selenium from wastewater.

### BACKGROUND OF THE INVENTION

Selenium has become a pollutant of concern around the world because of its potential effects on human health and the environment. In the USA, recently issued National Pollution Discharge Elimination System (NPDES) permits have forced industrial facilities to meet strict new discharge requirements for selenium (total selenium <10 μg/l). Several State Environmental Quality Boards have ruled that industries must achieve this selenium limitation in their surface water discharges. Globally, it is anticipated that the demand for processes that remove selenium to ppb levels in industrial effluents will be significant in the coming years.

There are many sources of selenium. Selenium is found in wastewater from coal mines, oil and gas extraction, petroleum refining, coal fired power generation, various mining industries, and other industrial activities. Selenium is even present in some irrigation water and in storm water runoff from agricultural operations located in areas with seleniferous soils. Granted, selenium is even a nutrient for biological systems. However, the safety margin between being a nutrient and being highly toxic is very narrow.

As water quality standards become stricter, conventional treatment processes are constrained in reducing selenium to sub-ppb levels. Current state-of-the-art technologies do not offer economically viable processes for reducing selenium to these levels. One example of a selenium removal process is the “ABMet” process offered by General Electric. See U.S. Pat. Nos. 6,183,644 and 8,163,181. This process and other commercial selenium removal processes have serious drawbacks. For example, many of these processes require the removal of nitrates and/or nitrites prior to the removal of selenium. Also, it is typical for the kinetics of commercially available biological processes to be slow. This results in high capital costs to build effective treatment plants. Also, in many cases, biological selenium removal processes rely on the removal of elemental selenium. Processes that require the removal of elemental selenium are challenging to perform efficiently. Finally, virtually all biological selenium removal processes are prone to produce significant concentrations of organic selenium, compounds that are far more toxic than selenates and selenites. The direct consequence of this is that the treated water may actually be more toxic than the water prior to treatment.

Therefore, there is a need for an efficient and cost effective selenium removal process which minimizes the production of elemental selenium, selenium −2 and organo-selenium species.

### SUMMARY OF THE INVENTION

The present invention relates to a biological selenium removal process for removing selenium and particularly selenium +6 species (selenates) from the water. Water is directed to a first biological reactor containing biomass and operated under anaerobic or anoxic conditions. Selenium +6 species are biologically reduced by the biomass to selenium +4 species (selenites) or absorbed on the biomass. Thereafter, the water containing the selenium +4 species is directed to a precipitation reactor. A coagulant, such as a ferric or aluminum salt, is mixed with the water. Solids having adsorption sites precipitate from the water. Selenium +4 species are adsorbed onto the adsorption sites of the solids. Thereafter, the solids having selenium +4 species adsorbed thereto, in addition to the sloughed biomass containing adsorbed selenium, are separated from the water. The water is further treated in a second biological reactor under aerobic conditions where the water is subjected to reoxygenation resulting in oxidizing the organo-selenium and any residual selenium +4 species back to selenium +6 species, which are generally considered to be less toxic than selenium +4 species and much less toxic than organo-selenium species.

In one embodiment, a biodegradable material, such as a carbon source, is added to the water in the first biological reactor to promote the biological reduction of selenium +6 species to selenium +4 species. Also, in some cases the water includes nitrates (N—NO₃) or nitrites (N—NO₂). NOₓ is used herein to refer to nitrates, nitrites or nitrates and nitrites. To minimize the reduction of selenium to elemental selenium and selenium −2 and to minimize the production of organic selenium, the dosage of the biodegradable material is controlled. Control is based on the ratio of chemical oxygen demand (COD) to NOₓ fed into the first biological reactor. It was found that production of elemental selenium and organic selenium can be minimized or reduced by dosing the biological reactor such that the ratio of COD to NOₓ is maintained in the range of 6-15.

In one specific embodiment, a process is described herein for removing selenium from water. This process entails directing the water containing selenium into a first biological reactor containing biomass. The water in this reactor is maintained under anoxic or anaerobic conditions. A carbon source is mixed with the water in the first biological reactor which gives rise to biologically reducing selenium +6 species to selenium +4 species while at least some of the selenium may be incorporated into the biomass. Thereafter, the process entails directing the water containing the selenium +4 species and the excess biomass from the first biological reactor to a downstream precipitation reactor. Here a coagulant is mixed with the water, causing solids having surface complexation binding sites to precipitate from the water. In the precipitation reactor, the selenium +4 species are adsorbed onto the complexation binding sites of the solids. At this point, the water containing the solids having the adsorbed selenium +4 species, as well as the biomass, is directed to a solids-liquid separator that separates the water from the solids having adsorbed selenium +4 species and the biomass. After this separation process, the water, substantially free of solids, is directed from the solids-liquid separator to a downstream second biological reox reactor operated under aerobic conditions. In the second biological reactor, the process entails oxidizing the water in the presence of air and removing most of any residual carbon source, and oxidizing most of the remaining selenium species in the water, including organo-selenium, to selenium +6.

Other objects and advantages of the present invention will become apparent and obvious from a study of the following description and the accompanying drawings which are merely illustrative of such invention.

### BRIEF DESCRIPTION OF THE DRAWING

FIG. 1 is a process flow diagram illustrating one embodiment of a process for removing selenium from water.

### DESCRIPTION OF EXEMPLARY EMBODIMENTS OF THE PRESENT INVENTION

The present invention is a system and process for removing selenium from water or wastewater. As used herein, “water” encompasses wastewater. That is, the terms “water” and “wastewater” are interchangeable. Fundamentally, the process relies heavily on biologically reducing selenate (selenium +6) to selenite (selenium +4) and minimizing the further reduction of selenium to elemental selenium or selenium −2. To remove the selenite from the water, solids are formed having surface complexations that serve as adsorption sites for selenite. Hence, selenite is absorbed onto the solids and the solids are subjected to a solids-liquid separation process where the solids having the adsorbed selenite are separated from the water. At this point, the water may still include residual selenium including organo-selenium, as well as residual biodegradable material that might have been used to facilitate the initial biological reactions that reduced selenate to selenite. To address these contaminants, the water is subjected to a second biological process that is operated under aerobic conditions to remove residual biodegradable material, as well as to oxidize residual selenium, including organo-selenium, back to selenate. Effluent from the second biological process is substantially free of selenium except for the possibility of a very small amount of selenate.

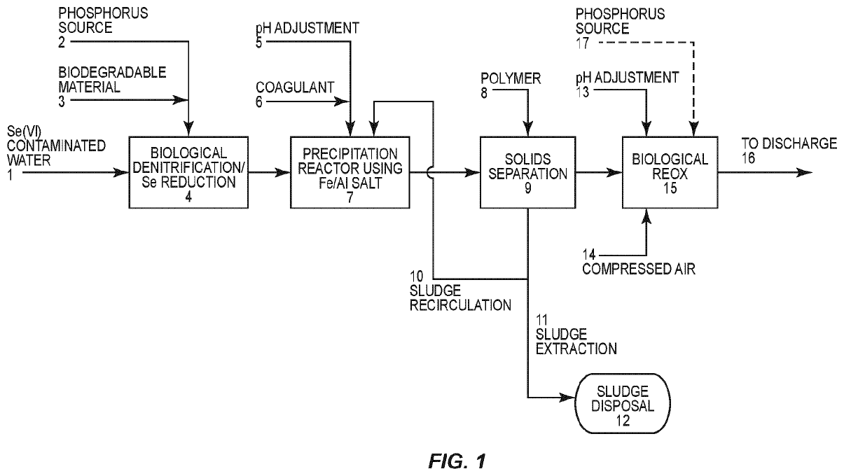

FIG. 1 illustrates an exemplary embodiment of the selenium removal process of the present invention. As discussed below, the process shown in FIG. 1 can be modified and expanded to accommodate various types of wastewater streams. With reference to FIG. 1, a wastewater stream 1 is directed into a biological mixed denitrification/selenium reduction reactor 4 (hereafter referred to as biological reactor 4 or a first biological reactor). Wastewater stream 1 is contaminated with selenate. In addition to selenate, wastewater stream 1 could typically include selenite, suspended solids, NOₓ, various metals, and other contaminants. Biological reactor 4 includes biomass and is operated under anaerobic or anoxic conditions. Biological reactor 4 is preferably operated as a moving bed biofilm reactor (MBBR). Details of an MBBR are not dealt with here because MBBRs are well known and appreciated by those skilled in the art and furthermore the MBBR employed in the process depicted in FIG. 1 is not per se material to the present invention. It should be noted, however, that suspended biomass, alone or in combination with fixed film biomass, can be employed in the biological reactors found in FIG. 1.

Biomass in biological reactor 4 serves two principal functions. First, the biomass reduces selenate to selenite. Secondly, if NOₓ are present in the wastewater, the biomass denitrifies the wastewater by reducing NOₓ to nitrogen gas. To support biomass growth in the biological reactor 4, a phosphorus source (stream 2) might be added to the reactor. Also, a biodegradable material (stream 3), such as a carbon source, is added to the biological reactor to promote the biological reduction reactions. The carbon source is generally a liquid sugar, such as glucose or glycerol. One example of an effective carbon source is glucose monohydrate.

Water containing the selenite is pumped from the biological reactor 4 to a mixed precipitation reactor 7. In the precipitation reactor 7, the water is mixed with a coagulant, a ferric or aluminum salt (stream 6), which results in the precipitation of solids having surface complexation binding sites. Selenite in the water is adsorbed onto the binding sites of the solids. It is preferable to exercise pH control over the water in the precipitation reactor 7. Generally, the pH should be maintained at neutral or slightly acidic. As shown in FIG. 1, pH adjustments can be made by directing an alkali or acid (stream 5) into the precipitation reactor 7 to provide optimal pH conditions for binding the selenite to surface complexation sites of the solids.

Water containing the adsorbed selenite, biomass from the biological reactor 4, and solids from the contaminated wastewater stream 1 is pumped to a solids-liquid separator 9. If required, a polymer (stream 8) can be mixed with the water in the solids-liquid separator 9 to facilitate the separation of solids from the water. Various types of solids-liquid separators can be employed. One such solids-liquid separator is a sand ballasted flocculation process marketed by Veolia Water Technologies under the name ACTIFLO. Other solids-liquid separation systems, such as ultrafiltration units, multimedia filtration units, filter presses, centrifugal separation units such as hydrocyclones or centrifuge, gravity separators such as settlers and decanters as well as disc and drum filters, dissolved air flotation (DAF) and dissolved gas flotation (DGF) units can be employed in the process depicted in FIG. 1. The solids-liquid separator 9 separates the water from the solids. The separated solids form a part of sludge. Sludge from the solids-liquid separator 9 is separated into two streams, streams 10 and 11. Sludge stream 10 is recycled to the precipitation reactor 7 and mixed with the water and other solids therein to further enhance the adsorption of selenite onto complexation sites of solids. After a selected retention time, a portion of the sludge is wasted via sludge stream 11.

Effluent from the solids-liquid separator 9 is substantially free of solids but may contain organic selenium, residual selenite and residual carbon source, if a carbon source is added to the biological reactor 4. This effluent is directed into a biological reox reactor 15 which includes biomass in the form of fixed film biomass and/or suspended biomass. Air is supplied via line 14 to the biological reox reactor 15 so as to maintain aerobic conditions in the reactor. This results in the removal of any residual carbon source, as well as the oxidation of organic selenium and residual selenite back to selenate. It is desirable to maintain the pH of the water in the biological reox reactor 15 in the range of 6 to 8. Accordingly, one or more pH adjustment reagents can be directed into the biological reox reactor 15 via line 13. Depending on the coagulant added in reactor 7, a very small dosage of phosphorus might also need be added to reactor 15.

To efficiently remove selenium according to the processes described above, it is desirable to minimize the formation of elemental selenium, selenium −2, as well as organic selenium. During testing, it was discovered that the formation of these forms of selenium could be reduced or minimized by controlling the dosage of the reducing agent (for example, the carbon source).

It was found that the initial dosage of the reducing agent could be estimated based on the ratio of COD (expressed as mass of COD per unit of time) to NOₓ (expressed as mass of NOₓ as N per unit of time) fed to the biological reactor 4 and maintaining the ratio of COD to NOₓ at 6-15, and preferably 8-12.

It was also found that the dosage of the reducing agent could be further optimized by maintaining the residual COD concentration in reactor 4 between 20 and 200 mg COD/L, or, alternatively, by keeping the redox potential in reactor 4 between −100 and +80 mV compared to a standard hydrogen electrodes. This is especially useful if there is little or no NOₓ in the selenium contaminated water (stream 1).

It was found that by both maintaining the ratio of COD to NOₓ at 6-15, and preferably 8-12, and controlling the residual COD concentrate or redox potential in reactor 4 by varying the dosage of the reducing agent, that the formation of organo-selenium, elemental selenium and selenium −2 is minimized. Based on this, control can be carried out by continuously determining the mass per unit time of COD and NOₓ fed into the biological reactor 4, determining the resulting ratio of COD to NOₓ, and measuring the residual COD concentrate or redox potential in reactor 4 and varying the dosage of the reducing agent directed into biological reactor 4 to maintain these control parameters.

### EXAMPLE

A laboratory test was run to reproduce the process as illustrated in FIG. 1 on a silver and lead hard-rock mining site. Water received from site was spiked with selenate and NOₓ to be more representative of the expected water quality in a couple of years of mining activities (worst case expected). The relevant parts of the chemical analysis for this example were:
pH of 8
71 mg N/L of NOₓ
47.9 μg/L of total selenium, mostly as selenate (98.5%)
545 mg/L of sulfate, expressed as SO₄²⁻

The selected biological treatment for this example was the moving bed biological reactor (MBBR), a fixed film and completely mixed biological treatment. The laboratory apparatus to reproduce the MBBR process at laboratory scale was a 5 L double-walled glass reactor, allowing temperature control using an industrial chiller.

The flowrate for the two biological reactors (reactor 4 and reactor 15) was maintained around 7-8 L/d to provide sufficient retention time to promote complete denitrification. A glucose monohydrate solution was dosed in reactor 4 (mechanically mixed anoxic denitrification reactor) at a rate of 6-10 g COD/g NOₓ and its dosage was manually adjusted according to the measured soluble residual COD in reactor 4. Water temperature was maintained at 6° C. through the final testing phase in both biological reactors, when the biological system was stable (mass balance are closing), on a 3 months old biomass. Reactor 15 was aerated using an air compressor, providing both oxygen and mixing to the system. The initial source of biomass for the two biological reactors came from seeded carriers taken in a nitrification application for municipal wastewater treatment.

The precipitation reactor step, as well as the solids separation step, were tested in batch conditions due to laboratory limitations. The selected technology for the solids separation was ballasted flocculation (reactor 9), with a precipitation reactor (reactor 7) upstream. The selected chemistry for the physico-chemical step was a ferric chloride coagulant, at a dosage of 62 mg Fe/L, used at an optimal pH of 6.5 for antimony and selenium removal. No pH adjustment was required in this particular example. No sludge recirculation was completed at laboratory scale; however, sludge recirculation should enhance the efficiency of metal removal and at the same time decrease coagulant requirements. Solids separation was aided using a dry anionic polyacrylamide polymer solution, as well as silica sand for high rate ballasted flocculation.

Water from the solid separation step was pumped in the biological reox reactor (reactor 15) at the moment of final water characterization, which was otherwise fed directly from the biological denitrification reactor (reactor 4) to provide sufficient biomass growth during laboratory testing.

The outflow was sampled in each of reactors 4 and 15, as well as at the exit of reactor 9 for performance assessment. The water samples were sent to specialized external laboratories according to their sampling and preservatives recommendations for characterization.

With the flowrate indicated above, which is believed to be close to the optimal design flowrate on a juvenile biomass, the relevant content of the water at the outlet of reactor 4 (biological denitrification reactor) and reactor 9 (solids separation), both operated in stable conditions, were:

| | Reactor 4 | After Reactor 9 |
|---|---|---|
| NO₃ (mg N/L) | 71 | <0.1 |
| SO₄ (mg SO₄²⁻/L) | 545 | 545 |
| Se total (μg/L) | 47.8 | 3.6 |
| Se particulate (μg/L) | 43.7 | 0.97 |
| Se dissolved (μg/L) | 4.1 | 2.58 |
| Se dissolved - inorganic | 1.73 (47%) | 0.37 (32%) |
| (μg/L) | | |
| Se dissolved - organic | 1.98 (53%) | 0.78 (68%) |
| (μg/L) | | |

Selenium concentration for this example was lowered from 47.9 μg/L to 3.6 μg/L using the combination of biological selenium reduction and physico-chemical removal. Most of the removal was observed through the solids separation step, as most of the selenium out of the biological step leaves as particulate (but not as elemental selenium as it was not detected by the external laboratory in charge of the selenium speciation). The balance of the dissolved selenium, mostly present as selenite, was removed through surface complexation in the precipitation reactor (reactor 7) and then removed from the stream in the solids separation step (reactor 9).

The impact of reactor 15 (biological reox) can be mostly assessed looking at the evolution of the species at the various points, since it could not be operated in continuous conditions as for the other processes. The dissolved inorganic selenium proportion out of reactor 9 was dropped to 32%, due to a good removal of the selenite portion (thus 68% of dissolved organic selenium species). After the biological reox step (reactor 15), the dissolved organic selenium fraction drops down to 8%, as 92% of the dissolved selenium is now in its inorganic form (mostly as selenates with some selenites). It is believed that the oxidation of the organic selenium to inorganic selenium significantly lowers its possible toxicity to the receiving environment.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A process for removing selenium from water comprising:
directing the water containing selenium into a first biological reactor containing biomass;
maintaining the water and biomass under anoxic or anaerobic conditions in the first biological reactor;
in the first biological reactor, mixing a carbon source with the water and biologically reducing selenium +6 species to selenium +4 species while at least some of the selenium is incorporated into the biomass;
directing the water containing the selenium +4 species and at least some of the biomass from the first biological reactor to a downstream precipitation reactor;
mixing a coagulant with the water in the precipitation reactor and causing solids having surface complexation binding sites to be precipitated from the water;
in the precipitation reactor, adsorbing selenium +4 species onto the complexation binding sites of the solids;
directing the water containing the solids having the adsorbed selenium +4 species and the biomass to a solids-liquid separator and separating the water from the solids having adsorbed selenium +4 species and the biomass;
directing the water, substantially free of solids, from the solids-liquid separator to a downstream second biological reox reactor operated under aerobic conditions; and
in the second biological reactor oxidizing the water in the presence of air and removing most of the residual carbon source, and oxidizing most of the remaining selenium species in the water, including organo-selenium, to selenium +6 species.

2. The process of claim 1 wherein the reduction of selenium +6 species to selenium +4 species in the first biological reactor is controlled to minimize the formation of selenium 0 and selenium −2.

3. The process of claim 1 wherein the coagulant is an iron or aluminum salt and wherein the solids onto which the selenium +4 species is absorbed is formed by mixing the iron or aluminum salt with the water in the precipitation reactor, and wherein the addition of the iron or aluminum salt forms the surface complexation binding sites onto which the selenium +4 species are adsorbed.

4. The process of claim 1 wherein the solids-liquid separator comprises a ballasted flocculation system, a disc or drum filter, a gravity separator, a centrifugal separator, an ultrafiltration unit, a multimedia filtration unit, a filter press or a dissolved air flotation or dissolved gas flotation unit.

5. The process of claim 1 including controlling the reduction of selenium +6 species to selenium +4 species by varying the dosage of the carbon source supplied to the first biological reactor.

6. The process of claim 5 wherein the dosage of the carbon source is controlled to meet a target range of residual chemical oxygen demand (COD) or redox potential.

7. The process of claim 1 wherein the solids separated by the solids-liquid separator form a sludge, and wherein the process includes recycling at least a portion of the sludge to the precipitation reactor for enhancing the adsorption of selenium +4 onto the complexation binding sites of the solids.

8. The process of claim 7 wherein the sludge is aged approximately one to 12 hours, preferably for 2 to 8 hours, more preferably for 3 to 6 hours, through recycling and after the sludge is aged, the sludge is wasted.

9. The process of claim 1 including minimizing or reducing the formation of elemental selenium, selenium −2 and organo-selenium by varying the amount of the carbon source added to the water in the first biological reactor so as to maintain a ratio of COD, expressed as mass of COD per unit time, to NOₓ, expressed as mass of NOₓ as N per unit time, fed to the first biological reactor at 6 to 15, preferably 8 and 12.

10. The process of claim 1 wherein the first and second biological reactors can be operated as a membrane biological reactor (MBR), moving bed biofilm reactor (MBBR), submerged bed biofilm reactor or with suspended growth biomass.

11. The process of claim 1 wherein the first and second biological reactors contain any of bacteria, fungi, algae, archaea, yeast, and such are allowed to grow and develop freely within the biological reactors.

12. The process of claim 1 wherein the carbon source includes sugars, alcohols, carboxylic acid or low molecular weight organic material or hydrogen gas.

13. The process of claim 1 wherein the reduction in the first biological reactor is controlled to minimize the formation of elemental selenium, selenium −2 and organo-selenium species.

14. The process of claim 1 wherein the solids having surface complexation binding site is formed by adding iron +3 (ferric iron) or aluminum +3 and providing sufficient time for the surface complexation sites to form, and adjusting the pH of the water in the precipitation reactor to allow adsorption of selenium +4 species onto the surface complexation sites.

15. The process of claim 1 including varying the dosage of the carbon source mixed with the water in the first biological reactor to maintain the residual COD concentration in the first biological reactor between 20 and 200 mg/L.

16. The process of claim 1 wherein the dosage of the carbon source is, less preferably, adjusted by keeping the redox potential in the first biological reactor between −100 and +80 mV compared to a standard hydrogen electrode, preferably between-50 and 0 mV.

17. The process of claim 1 wherein the coagulant includes a soluble ferric or aluminum salt taken from the group including ferric chloride, ferric sulfate, aluminum chloride or aluminum sulfate.

18. The process of claim 17 wherein the coagulant dosage varies between 10 and 200 mg Fe/L or 5 or 100 mg Al/L, preferably 20 to 100 mg Fe/L or 10 to 50 mg Al/L.

19. The process of claim 1 wherein in the case the coagulant is ferric iron, the pH is maintained between 4 and 9, preferably 5 to 8, even more preferably between 6 and 7, wherein in the case the coagulant is aluminum the pH is maintained between 3 and 8, preferably 4 to 7, even more preferably between 5 and 6.

20. The process of claim 1 where oxidation in the second biological reactor is allowed to proceed until the residual soluble COD in the second biological reactor is between 2 and 50 mg/L, preferably 3 and 20 mg/L, more preferably 5 to 10 mg/L.

21. A process for removing selenium from water comprising:
directing the water containing selenium into a first biological reactor containing biomass;
maintaining the water and biomass under anoxic or anaerobic conditions in the first biological reactor;
in the first biological reactor, mixing a carbon source with the water and biologically reducing selenium +6 species to selenium +4 species while at least some of the selenium is incorporated into the biomass;
directing the water containing the selenium +4 species and at least some of the biomass from the first biological reactor to a downstream precipitation reactor;
mixing a coagulant with the water in the precipitation reactor and causing solids having surface complexation binding sites to be precipitated from the water;
in the precipitation reactor, adsorbing selenium +4 species onto the complexation binding sites of the solids;
directing the water containing the solids having the adsorbed selenium +4 species and the biomass to a solids-liquid separator and separating the water from the solids having adsorbed selenium +4 species and the biomass;
directing the water, substantially free of solids, from the solids-liquid separator to a downstream second biological reox reactor operated under aerobic conditions;
in the second biological reactor oxidizing the water in the presence of air and removing most of the residual carbon source, and oxidizing most of the remaining selenium species in the water, including organo-selenium, to selenium +6 species; and
minimizing or reducing the formation of elemental selenium, selenium −2 or organo-selenium by:
determining the amount of COD expressed as mass of COD per unit time introduced into the first biological reactor;
determining the amount of NOₓ expressed as mass of NOₓ as N per unit time introduced into the first biological reactor; and
varying the dosage of the amount of the carbon source introduced into the first biological reactor so as to maintain a COD to NOₓ ratio of 6 to 15, preferably 8 to 12.

22. A process for removing selenium from water comprising:
directing the water containing selenium into a first biological reactor containing biomass;
maintaining the water and biomass under anoxic or anaerobic conditions in the first biological reactor;
in the first biological reactor, mixing a carbon source with the water and biologically reducing selenium +6 species to selenium +4 species while at least some of the selenium is incorporated into the biomass;
directing the water containing the selenium +4 species and at least some of the biomass from the first biological reactor to a downstream precipitation reactor;
mixing a coagulant with the water in the precipitation reactor and causing solids having surface complexation binding sites to be precipitated from the water;
in the precipitation reactor, adsorbing selenium +4 species onto the complexation binding sites of the solids;
directing the water containing the solids having the adsorbed selenium +4 species and the biomass to a solids-liquid separator and separating the water from the solids having adsorbed selenium +4 species and the biomass;
directing the water, substantially free of solids, from the solids-liquid separator to a downstream second biological reox reactor operated under aerobic conditions;
in the second biological reactor oxidizing the water in the presence of air and removing most of the residual carbon source, and oxidizing most of the remaining selenium species in the water, including organo-selenium, to selenium +6 species; and
minimizing or reducing the formation of elemental selenium, selenium-2 or organo-selenium by:
determining the residual COD concentration in the first biological reactor; and
varying the dosage of the carbon source introduced into the first biological reactor to maintain the residual COD concentration in the first biological reactor between 20 and 200 mg/L.
